(19) United States
(12) Patent Application Publication
(10) Pub. No.: US 2026/0131709 A1
(43) Pub. Date: May 14, 2026

(54) VEHICLE SEAT FRAME AND VEHICLE SEAT

(71) Applicant: NHK SPRING CO., LTD., Yokohama-shi (JP)

(72) Inventors: Minoru TAKAKURA, Yokohama-shi (JP); Hideaki YOSHINO, Yokohama-shi (JP)

(21) Appl. No.: 19/384,959

(22) Filed: Nov. 10, 2025

(30) Foreign Application Priority Data
Nov. 13, 2024 (JP) 2024-198637

(51) Int. Cl. B60N 2/68

(52) U.S. Cl. CPC B60N 2/686; B60N 2/682

(57) ABSTRACT

There is provided a seatback in which plural tubular portions are formed in a back frame by bending a single panel, and the plural tubular portions respectively configure closed cross-sections. Here, respective end portions of the tubular portions are joined to each other by being abutted and welded at joining portions, and the closed cross-sections of the tubular portions are continuous with each other. Therefore, the strength of the end portions of the tubular portions of the back frame can be increased.

### CROSS-REFERENCE TO RELATED APPLICATION

This application is based on and claims priority under 35 USC 119 from Japanese Patent Application No. 2024-198637 filed on Nov. 13, 2024, the disclosure of which is incorporated by reference herein.

### BACKGROUND

### Technical Field

The present invention relates to a vehicle seat frame including a plurality of closed cross-section portions, and a vehicle seat including the vehicle seat frame.

### Related Art

In a seatback described in Japanese Patent Application Laid-Open No. 2009-96354, a front frame portion and a rear frame portion are provided in a seat frame, a single steel plate is bent to form the front frame portion and the rear frame portion, and the front frame portion and the rear frame portion have respective closed cross-sections.

Here, in the seatback, the closed cross-section of the front frame portion and the closed cross-section of the rear frame portion are not continuous.

### SUMMARY

With this in view, an object of the present invention is to obtain a vehicle seat frame and a vehicle seat enabling strength of an end portion of a closed cross-section portion to increase.

A vehicle seat frame of a first aspect of the present invention includes: a plurality of closed cross-section portions respectively configuring closed cross-sections and being formed by bending a single plate material; and a joining portion at which respective end portions of the closed cross-section portions are joined to each other, by being abutted and welded such that the closed cross-section portions are continuous with each other.

In the vehicle seat frame of the first aspect of the present invention, the plurality of closed cross-section portions are formed by bending the single plate material, and the plurality of closed cross-section portions respectively configure closed cross-sections.

Here, respective end portions of the closed cross-section portions are joined to each other by being abutted and welded at the joining portion, and the closed cross-sections are continuous with each other. Therefore, strength of the end portions of the closed cross-section portions can be increased.

According to the vehicle seat frame of the first aspect of the present invention, in the vehicle seat frame of a second aspect of the present invention, a corner portion is configured by the end portions of the closed cross-section portions.

In the vehicle seat frame of a second aspect of the present invention, a corner portion is configured by the end portions of the closed cross-section portions. Therefore, the strength of the corner portion can be increased.

According to the vehicle seat frame of the first or second aspect of the present invention, the vehicle seat frame of a third aspect of the present invention includes an extension bent portion that extends from the closed cross-section portion and is bent.

In the vehicle seat frame of the third aspect of the present invention, the extension bent portion extends from the closed cross-section portion and is bent. Therefore, the extension bent portion enables the strength of the closed cross-section portions to be increased.

According to the vehicle seat frame of any one of the first to third aspects of the present invention, the vehicle seat frame of a fourth aspect of the present invention includes an extension coupling portion that extends from the closed cross-section portion and is coupled to the closed cross-section portions.

In the vehicle seat frame of the fourth aspect of the present invention, the extension coupling portion extends from the closed cross-section portion and is coupled to the closed cross-section portion. Therefore, the extension coupling portion enables the strength of the closed cross-section portions to be increased.

A vehicle seat of a fifth aspect of the present invention includes: a seat cushion at which an occupant is seated; a seatback supporting a back part of the occupant; and the vehicle seat frame according to any one of the first to fourth aspects of the present invention provided at at least one of the seat cushion or the seatback.

In the vehicle seat of the fifth aspect of the present invention, the occupant is seated on the seat cushion, and the seatback supports the back part of the occupant.

Here, the vehicle seat frame according to any one of the first to fourth aspects of the present invention is provided at at least one of the seat cushion or the seatback. Therefore, the same effects as those of any one of the first to fourth aspects of the present invention can be obtained.

### BRIEF DESCRIPTION OF THE DRAWINGS

Exemplary embodiments of the present invention will be described in detail based on the following figures, wherein:

FIG. 1 is a left side view illustrating a vehicle seat according to a first embodiment of the present invention;

FIG. 2 is a diagonal front left perspective view illustrating a back frame of the vehicle seat according to the first embodiment of the present invention;

FIG. 3A is a cross-sectional top view (cross-sectional view taken along line 3A-3A in FIG. 2) of the back frame of the vehicle seat according to the first embodiment of the present invention;

FIG. 3B is an unfolded view of the back frame of the vehicle seat according to the first embodiment of the present invention;

FIG. 4A is a cross-sectional top view (cross-sectional view taken at a position along line 3A-3A in FIG. 2) illustrating a back frame of a vehicle seat according to a second embodiment of the present invention;

FIG. 4B is an unfolded view of the back frame of the vehicle seat according to the second embodiment of the present invention;

FIG. 5A is a cross-sectional top view (cross-sectional view taken at a position along line 3A-3A in FIG. 2) illustrating a back frame of a vehicle seat according to a third embodiment of the present invention;

FIG. 5B is an unfolded view of the back frame of the vehicle seat according to the third embodiment of the present invention;

FIG. 6A is a cross-sectional top view (cross-sectional view taken at a position along line 3A-3A in FIG. 2) illustrating a back frame of a vehicle seat according to a fourth embodiment of the present invention; and

FIG. 6B is an unfolded view of the back frame of the vehicle seat according to the fourth embodiment of the present invention.

### DETAILED DESCRIPTION

### First Embodiment

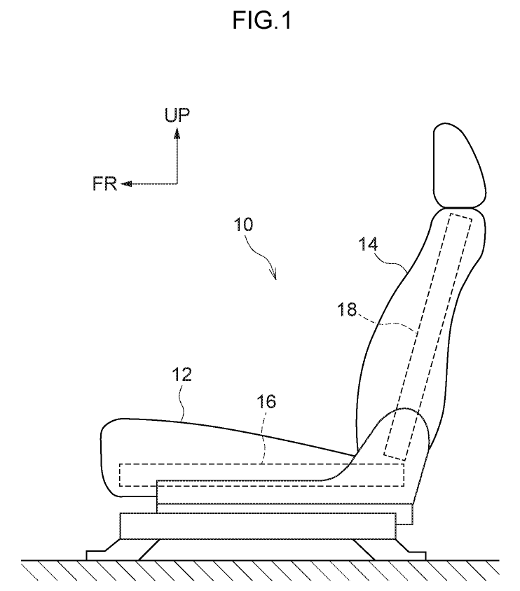

FIG. 1 is a left side view of a vehicle seat 10 according to a first embodiment of the present invention. In the figures, a frontward direction of the vehicle seat 10 is represented by an arrow FR, a rightward direction of the vehicle seat 10 is represented by an arrow RH, and an upward direction of the vehicle seat 10 is represented by an arrow UP.

The vehicle seat 10 in this embodiment is provided in a vehicle interior of a vehicle (automobile).

As illustrated in FIG. 1, a seat cushion 12 is provided at a lower portion of the vehicle seat 10, and a passenger of the vehicle sits on the seat cushion 12. A seatback 14 is provided at an upper side of a rear end portion of the seat cushion 12, and the seatback 14 supports a back part of the occupant.

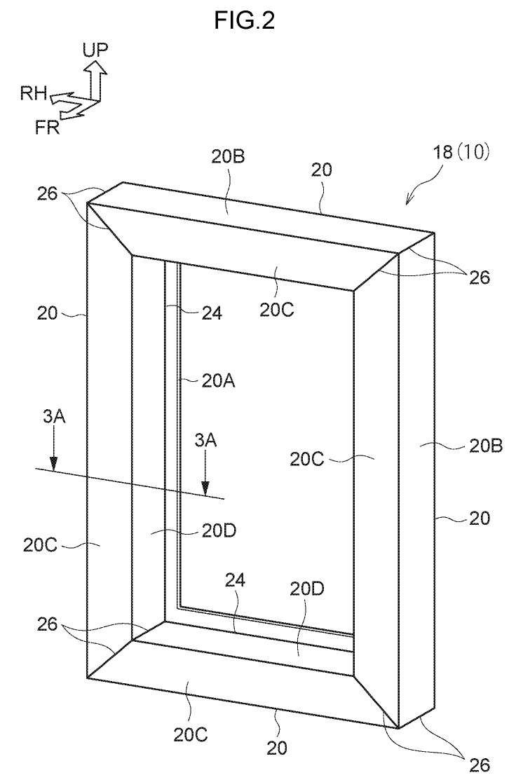

A metal cushion frame 16 having a rectangular frame shape in plan view is provided in the seat cushion 12, and the cushion frame 16 forms a framework of the seat cushion 12. A metal back frame 18 (see FIG. 2) having a rectangular frame shape in front view is provided as a vehicle seat frame in the seatback 14, and the back frame 18 forms a framework of the seatback 14.

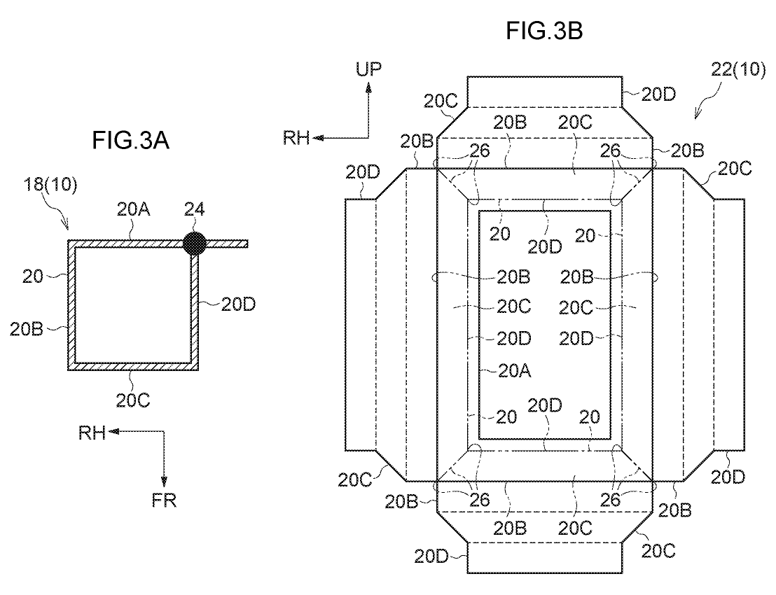

Tubular portions 20 having a substantially rectangular tube shape are provided as respective closed cross-section portions at an upper portion, a lower portion, a left portion, and a right portion of the back frame 18, and end portions (end portions in an axial direction) of the tubular portion 20 form corner portions (corner portions in a circumferential direction) of the back frame 18. The tubular portion 20 has a rectangular closed cross-section, and a rear wall of the tubular portion 20 extends to an inner peripheral side of the back frame 18 (see FIG. 3A).

The back frame 18 is formed of a single panel 22 as a plate material, and the panel 22 has a substantially rectangular annular plate shape (see FIG. 3B). An inner peripheral portion of the panel 22 is formed of a rear wall portion 20A having a rectangular annular shape, and the rear wall portion 20A forms rear walls of all of the tubular portions 20. The panel 22 includes a rectangular outer wall portion 20B integrally provided on an outer peripheral side of each outer side of the rear wall portion 20A, and the outer wall portion 20B forms an outer wall of the tubular portion 20 (a wall on an outer peripheral side of the back frame 18). The panel 22 includes a trapezoidal front wall portion 20C integrally provided on an outer peripheral side of the outer wall portion 20B, and the front wall portion 20C forms a front wall of the tubular portion 20. The panel 22 includes a rectangular inner wall portion 20D integrally provided on an outer peripheral side of the front wall portion 20C, and the inner wall portion 20D forms an inner wall of the tubular portion 20 (a wall on the inner peripheral side of the back frame 18).

The tubular portion 20 is formed by bending over the panel 22 between the rear wall portion 20A and the outer wall portion 20B, between the outer wall portion 20B and the front wall portion 20C, and between the front wall portion 20C and the inner wall portion 20D. An outer peripheral-side end of the inner wall portion 20D is joined to a plate surface of the rear wall portion 20A by being abutted and welded (butt-welded), and a formation joining portion 24 is formed between the outer peripheral-side end of the inner wall portion 20D and the plate surface of the rear wall portion 20A. An end portion of the outer wall portion 20B, an end portion of the front wall portion 20C, and an end portion of the inner wall portion 20D in the tubular portion 20 which are adjacent to each other are arranged along each other and joined by being abutted and welded, and joined portions 26 are formed between the end portions of the outer wall portions 20B, between the end portions of the front wall portions 20C, and between the end portions of the inner wall portions 20D. Therefore, closed cross-sections of the adjacent tubular portions 20 are continuous.

Next, operations of this embodiment will be described.

In the seatback 14 of the vehicle seat 10 having the configuration described above, the single panel 22 is bent over to form the plurality of tubular portions 20 in the back frame 18, and the plurality of tubular portions 20 respectively configure closed cross-sections.

Here, respective end portions of the tubular portions 20 are joined to each other by being abutted and welded at the joining portions 26, and the closed cross-sections of the tubular portions 20 are continuous with each other. Therefore, the strength of the end portion of each of the tubular portions 20 of the back frame 18 can be increased.

Further, a corner portion of the back frame 18 is formed by the end portion of the tubular portions 20. Therefore, the strength of the end portions of the tubular portions 20 of the back frame 18 can be increased such that the strength of the corner portion of the back frame 18 can be increased.

### Second Embodiment

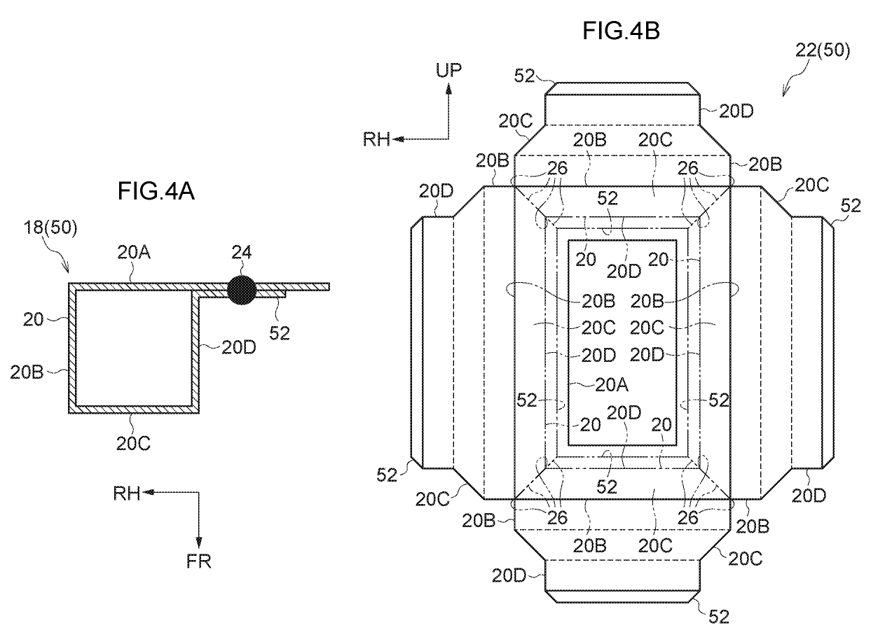

FIG. 4A is a cross-sectional top view of the back frame 18 of a vehicle seat 50 according to a second embodiment of the present invention (a cross-sectional view taken at a position along line 3A-3A in FIG. 2), and FIG. 4B is an unfolded view of the back frame 18 of the vehicle seat 50.

The vehicle seat 50 according to this embodiment has substantially the same configuration as that of the first embodiment and differs in the following points.

As illustrated in FIGS. 4A and 4B, the back frame 18 of the vehicle seat 50 according to this embodiment includes a trapezoidal overlapping portion 52 integrally provided on the outer peripheral side of the inner wall portion 20D in the panel 22, and the overlapping portion 52 forms a rear wall of the tubular portion 20.

The panel 22 is bent over between the inner wall portion 20D and the overlapping portion 52, and the overlapping portion 52 projects from the tubular portion 20 toward the inner peripheral side. The overlapping portion 52 is joined to the rear wall portion 20A by lap welding, and a formation joining portion 24 is formed between the overlapping portion 52 and the rear wall portion 20A. End portions of the overlapping portions 52 adjacent to each other are arranged along each other and joined by being abutted and welded, and a joined portion 26 is formed between the end portions of the overlapping portions 52.

Here, also in this embodiment, the same functions and effects as those of the first embodiment can be obtained.

Further, at the corner portion of the back frame 18, the end portions of the overlapping portions 52 are joined to each other by abutting and welding the joined portions 26. Therefore, the strength of the end portions of the tubular portions 20 of the back frame 18 can be further increased, and the strength of the corner portions of the back frame 18 can be further increased.

### Third Embodiment

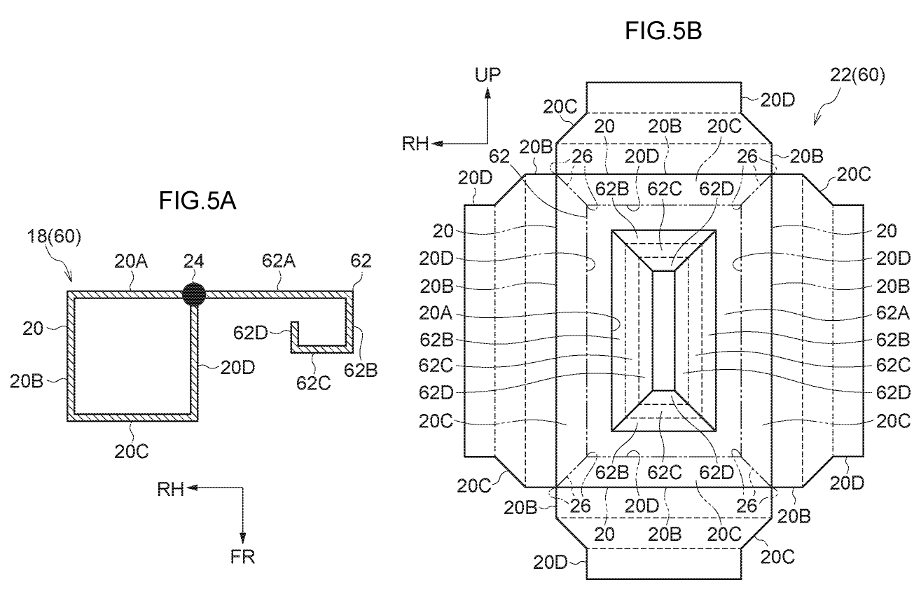

FIG. 5A is a cross-sectional top view of the back frame 18 of a vehicle seat 60 according to a third embodiment of the present invention (a cross-sectional view taken at a position along line 3A-3A in FIG. 2), and FIG. 5B is an unfolded view of the back frame 18 of the vehicle seat 60.

The vehicle seat 60 according to this embodiment has substantially the same configuration as that of the first embodiment and differs in the following points.

As illustrated in FIGS. 5A and 5B, in the back frame 18 of the vehicle seat 60 according to this embodiment, an extension portion 62 as an extension bent portion extends from the tubular portion 20 to the inner peripheral side.

In the panel 22, a portion of the rear wall portion 20A on the inner peripheral side from the tubular portion 20 forms a first extension portion 62A having a rectangular annular shape included in the extension portion 62. The panel 22 includes a trapezoidal second extension portion 62B integrally provided on the inner peripheral side of each inner side of the first extension portion 62A (the rear wall portion 20A), the second extension portion 62B being included in the extension portion 62, and the second extension portion 62B is bent over toward a front side with respect to the first extension portion 62A. The panel 22 includes a trapezoidal third extension portion 62C integrally provided on the inner peripheral side of the second extension portion 62B, the third extension portion 62C being included in the extension portion 62, and the third extension portion 62C is bent over toward the outer peripheral side with respect to the second extension portion 62B. The panel 22 includes a trapezoidal fourth extension portion 62D integrally provided on the inner peripheral side of the third extension portion 62C, the fourth extension portion 62D being included in the extension portion 62, and the fourth extension portion 62D is bent over a rear side with respect to the third extension portion 62C.

Here, also in this embodiment, the same functions and effects as those of the first embodiment can be obtained.

Further, in the back frame 18, the extension portion 62 (the first extension portion 62A, the second extension portion 62B, the third extension portion 62C, and the fourth extension portion 62D) extends toward the inner peripheral side from the tubular portion 20 and is bent over. Therefore, the strength of the tubular portion 20 can be increased by the extension portion 62.

The extension portion 62 of the panel 22 is included in the back frame 18. Therefore, a yield of the back frame 18 can be improved.

### Fourth Embodiment

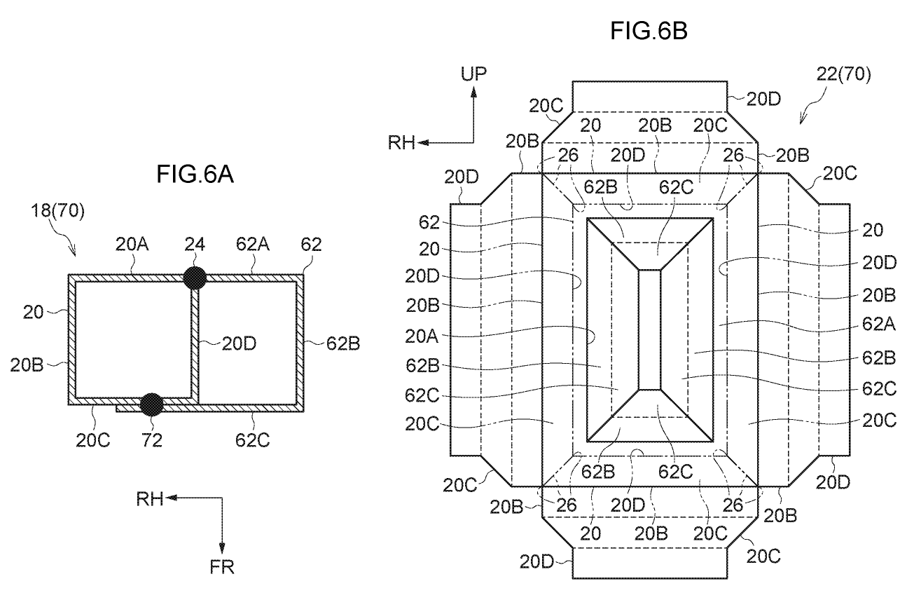

FIG. 6A is a cross-sectional top view of the back frame 18 of a vehicle seat 70 according to a fourth embodiment of the present invention (a cross-sectional view taken at a position along line 3A-3A in FIG. 2), and FIG. 6B is an unfolded view of the back frame 18 of the vehicle seat 70.

The vehicle seat 70 according to this embodiment has substantially the same configuration as that of the third embodiment and differs in the following points.

As illustrated in FIGS. 6A and 6B, in the back frame 18 of the vehicle seat 70 according to this embodiment, the extension portion 62 functions as the extension bent portion and an extension coupling portion.

In the extension portion 62, the second extension portion 62B extends toward the front side, and the third extension portion 62C extends toward the outer peripheral side, and the fourth extension portion 62D is not provided in the extension portion 62. The third extension portion 62C is coupled to the front wall portion 20C of the tubular portion 20 by spot welding, plug welding, laser welding, or the like, and a coupling portion 72 is formed between the front wall portion 20C and the third extension portion 62C.

Here, also in this embodiment, the same functions and effects as those of the third embodiment can be obtained.

Further, in the back frame 18, the extension portion 62 (the first extension portion 62A, the second extension portion 62B, and the third extension portion 62C) extends toward the inner peripheral side from the tubular portion 20 and is coupled to the tubular portion 20. Therefore, the extension portion 62 enables the strength of the tubular portions 20 to be further increased.

The second embodiment described above is applied to the first embodiment described above. However, the second embodiment described above may be applied to the third embodiment or the fourth embodiment.

Further, in the first to fourth embodiments, the back frame 18 includes the four tubular portions 20. However, the back frame 18 may include two, three, five tubular portions 20 or more.

In the first to fourth embodiments, the vehicle seat frame is applied to the back frame 18. However, the vehicle seat frame may be applied to the cushion frame 16.

What is claimed is:

1. A vehicle seat frame, comprising:
a plurality of closed cross-section portions respectively configuring closed cross-sections and being formed by bending a single plate material; and
a joining portion at which respective end portions of the closed cross-section portions are joined to each other, by being abutted and welded such that the closed cross-section portions are continuous with each other.

2. The vehicle seat frame according to claim 1, wherein a corner portion is configured by the end portions of the closed cross-section portions.

3. The vehicle seat frame according to claim 1, comprising an extension bent portion that extends from the closed cross-section portion and is bent.

4. The vehicle seat frame according to claim 3, wherein the extension bent portion is bent toward an inner side of the plurality of closed cross-section portions.

5. The vehicle seat frame according to claim 1, comprising an extension coupling portion that extends from the closed cross-section portion and is coupled to the closed cross-section portion.

6. The vehicle seat frame according to claim 1, wherein the closed cross-section portion is formed by being abutted and welded.

7. The vehicle seat frame according to claim 1, wherein the closed cross-section portion is formed by lap welding.

8. The vehicle seat frame according to claim 1, wherein the plate material projects from the closed cross-section portion toward an inner peripheral side of the plurality of closed cross-section portions.

9. The vehicle seat frame according to claim 1, wherein the plate material projects from a rear side of the closed cross-section portion.

10. A vehicle seat, comprising:
a seat cushion at which an occupant is seated;
a seatback supporting a back part of the occupant; and
the vehicle seat frame according to claim 1, provided at at least one of the seat cushion or the seatback.
